(19) United States
(12) Patent Application Publication
(10) Pub. No.: US 2018/0253657 A1
(43) Pub. Date: Sep. 6, 2018

(54) REAL-TIME CREDIT RISK MANAGEMENT SYSTEM

(71) Applicants: Liang Zhao, San Diego, CA (US); Jiayi Hou, San Diego, CA (US)

(72) Inventors: Liang Zhao, San Diego, CA (US); Jiayi Hou, San Diego, CA (US)

(21) Appl. No.: 15/820,340

(22) Filed: Nov. 21, 2017

Related U.S. Application Data
(60) Provisional application No. 62/466,135, filed on Mar. 2, 2017.

(51) Int. Cl. G06N 7/00; G06N 99/00; G06Q 40/02; G06Q 50/00

(52) U.S. Cl. CPC G06N 7/005; G06Q 50/01; G06Q 40/025; G06N 99/005

(57) ABSTRACT

The present invention generally relates to a system and method for incorporating computational infrastructure within a statistical learning framework for real-time risk assessment and decision making.

### CROSS-REFERENCE TO RELATED APPLICATIONS

This application claims the benefit of U.S. Provisional Patent Application No. 62/466,135, filed Mar. 2, 2017, titled “REAL-TIME CREDIT RISK MANAGEMENT SYSTEM,” the entire disclosure of which is incorporated herein by reference.

### FIELD OF THE INVENTION

The present invention relates generally to the personal finance, credit risk and banking field, and more particularly to the field of credit scoring methods and systems. Preferred embodiments of the present invention provide systems and methods for incorporating computational infrastructure within a statistical learning framework for real-time risk assessment and decision making. More particularly, the present invention relates to improved systems for scoring borrower credit, which includes individuals, and other types of entities including, but not limited to, corporations, companies, small businesses, and trusts, and any other recognized financial entity.

### BACKGROUND OF THE INVENTION

Banks reply on an authentic credit scoring system to evaluate a person or entity's payback ability. The traditional credit scoring system invented in the 1970's were still in use today. Traditional credit scoring system only allows a handful number of risk factors (also known as covariates) to be considered in order to determine the likelihood of an applicant or to default. These covariates are limited to 1) numeric covariate with continuous values; 2) non-numeric categorical covariates with multiple levels, which can be converted to several dummy covariates; and 3) other non-numeric covariates, which may be combined but may not be converted to numeric values. For example, traditional credit scoring system incorporated demographic covariates: applicant's age (continuous), annual income (continuous), gender (two-level categorical: female and male), home ownership (four-level categorical: rent, own, mortgage and other) and applicant's address (non-numeric covariate). Typically, the full information of the string characters cannot be implemented to the credit scoring system directly; the partial information is often extracted as a component for decision making. For example, applicant's address is a string character, which consists of house number, street name, city, state and zip code. Often, only the zip code is used by the credit scoring system as a surrogate to income, as a risk factor to determine one's payback ability

The traditional credit scoring works by computing a composite score from a handful of risk factors based on a fixed formula. In the formula, the coefficients or weights associated with risk factors are often pre-determined from previous experience or public data. By assuming an applicant's payback ability is highly associated with the value of the composite score, the system can determine the grantsmanship of the application to a loan or credit. Most commonly, instead of using the composite score on a continuous scale, the system dichotomizes the score to a status such as approve or decline an application. The threshold can be either arbitrary, or determined by the receiver operating characteristic.

For example, an applicant living in a lower income neighborhood is less likely to get their loan application approved as compared to applicants share similar qualifications and demographics, but are living in higher-income neighborhood. In a relevant issue, only two stationary possible decisions are made: approving or declining according to the probability estimated from the traditional credit scoring system. The cutoff for the probability is arbitrary and the decision is static. In addition, there is no amount and duration of loan or credit to be issued involved in any part of the decision-making process. In other words, the decision-making follows exactly the same procedure regardless of whether an applicant is requesting a loan in the amount of one hundred or one hundred thousand dollars. In addition, the rankings of consumer creditworthiness from traditional credit scoring systems are stationary and invariant with respect to macroeconomic factors change. For example, during period of economic recession, consumers may increase their credit card borrowing while simultaneously being exposed to decreased income. The traditional credit scoring systems can therefore often fail to capture the time-dependent change, which may amplify the systematic risk.

A traditional credit scoring system is also limited by the amount of the data it can process simultaneously—for both the number of applicants and number of covariates. For example, a classical risk model FICO score by Fair Isaac Corporation consists of only five covariates: (1) payment history, (2) credit utilization, (3) length of credit history, (4) types of credit used, and (5) recent credit inquiry. It also lacks mechanism to impute missing data. A substantial removal of observations with missing data can lead to biased result. None of the traditional credit scoring systems adapt to the big data era by incorporating non-traditional consumer data, such as transaction data, social media data, which often comes with thousands, tens of thousands, or millions covariates with weak signals. All of the aforementioned issues largely prevent the usage of advanced analytical techniques with higher degree of complexity that yield more accurate results. Thus, an improved system for ranking consumer creditworthiness and risk management is desired.

### SUMMARY OF THE INVENTION

To improve upon existing systems, preferred embodiments of the present invention provide a data processing system for incorporating network-based computational infrastructure within a statistical learning framework for real-time risk assessment and decision making. The data processing system can receive a request to display content containing the information resource and can also evaluate an applicant's ability to pay back a loan. The system can receive a request for content to display a decision such as whether to issue or to decline a loan and the amount of the loan. The preferred embodiments of the present invention provide a method to evaluate, for an information resource, the likelihood that an applicant will pay back a loan at a given point in time.

One preferred method for incorporating computational infrastructure within a statistical learning framework for real-time risk assessment and decision making can include capturing a borrower's profile and the macro economic factors to generate RAW DATA; managing and preparing the RAW DATA to generate CLEAN DATA for downstream analytics; pre-screening the predictor space to remove excessive noise and stabilize the variable selection procedure; conducting a real-time statistical machine learning algorithm to process the CLEAN DATA to further reduce dimensionality in the clean data; constructing an individualized risk score for each type of event, namely a default and a prepayment, using the predictors selected in the previous step; evaluating and comparing the ways of segmented risk in order to assess the overall risk. In some embodiments, managing and preparing the RAW DATA to generate CLEAN DATA can include removing outliers, imputing missing transformation covariates with skewed distribution to meet the normality assumption, and converting strings or characters to numeric values.

The preferred embodiments of the present invention may also be used to distinguish the borrower's profiles associated with the different types of risks (e.g. in the event of default and prepayment) and to simultaneously estimate the two conditional probability of failures to form a competing risk model. In sharp contrast to a traditional credit scoring system, where default is considered as the primary and sole event, the two types of events (default and prepayment) compete with each other and are mathematically non-identifiable (i.e. credit-debt that has prepaid cannot default, and vice versa). Thus, the competing risk model is built upon the joint distribution of the event time, which is assumed to be mutually independent. Both default and prepayment rates are affected by individual-level stationary covariates, such as borrower's demographics and credit history when applying. They can also be strongly impacted by macroeconomic risk factors, such as current prime interest rate. For example, when the interest rate drops, the rate of prepayment rises, leaving fewer debts to default. The framework is also capable of incorporating more complex types of competing risks with multi-state model. For example, the types of events can be generalized to: prepayment, in grace period, 15-30 days late, 30-60 days late, and default. Other variations, features, and aspects of the system and method of the preferred embodiment are described in detail below with reference to the appended drawings.

In accordance with a preferred embodiment of the present invention a system for incorporating computational infrastructure within a statistical learning framework for evaluating multiple types of risk simultaneously and decision making comprises: at least one user device; at least one central computer; a data processing system; at least one data source selected from the group comprising a borrower data source; a credit bureau data source, a history data source, a transaction data source, an economic data source, and a social media data source; and a network communicatively connecting the user device, said at least one computer, and the data source. The central computer is a server and the data processing system further comprises: a collect unit, a process unit, and an analyze unit in the preferred embodiment of the present invention. In accordance with a preferred embodiment of the present invention, the collect unit comprises at least one scalable storage infrastructure, the process unit includes an interface for data parallelism and fault tolerance, and the user device is operable to access information resources on the network via at least one of HTTP, REST architectural style, and SOAP protocol.

In accordance with a preferred embodiment of the present invention, a method for incorporating computational infrastructure within a statistical learning framework for evaluating multiple types of risk simultaneously for decision making comprises: the step of receiving a borrower's profile; the step of generating raw data; the step of cleaning and transforming the raw data to generate clean data therefrom; the step of pre-screening the clean data to remove excessive noise and stabilize a variable selection procedure; the step of processing the clean data using at least one statistical machine learning algorithm to reduce the dimensionality of the clean data; the step of evaluating and comparing risk segmentation options; and the step of selecting a best model and a best segmentation. Additionally the method, in accordance with a preferred embodiment of the present invention, further comprises the step of storing the raw data within a scalable storage infrastructure. In accordance with a preferred embodiment of the present invention, the step of generating raw data comprises the steps of collecting borrower data collecting credit bureau data; collecting history data; collecting transaction data; collecting economic data; and collecting social media data. The borrower data comprises: a borrower's demographic profile; state of residence; annual income; marital status; and home ownership status; the credit bureau data comprises: a FICO score, a number of collections within a prior time period; types of credit lines; and a payment status history within a prior time period; and the transaction data comprises: an applicant's transaction history, and phone activity data.

In accordance with a preferred embodiment of the present invention, a system for incorporating computational infrastructure within a statistical learning framework for evaluating multiple types of risk simultaneously and decision making comprises a non-transitory, computer readable recording medium containing a computer program, which when executed by at least one of a plurality of processors, causes the at least one of a plurality of processors to perform the steps of: receiving a borrower's profile; generating raw data; cleaning and transforming the raw data to generate clean data therefrom; pre-screening the clean data to remove excessive noise and stabilize a variable selection procedure; processing the clean data using at least one statistical machine learning algorithm to reduce the dimensionality of the clean data; evaluating and comparing risk segmentation options; and selecting a best model and a best segmentation. The system may further comprise a non-transitory, computer readable recording medium containing a computer program, which when executed by the at least one of a plurality of processors, causes the at least one of a plurality of processors to perform the step of storing the raw data within a scalable storage infrastructure. In accordance with a preferred embodiment of the present invention the sequence steps of processing the clean data using at least one statistical machine learning algorithm to reduce the dimensionality of the clean data, evaluating and comparing risk segmentation options, and selecting a best model and a best segmentation are performed via parallel computing wherein the sequence is performed on each of the at least one of a plurality of processors in the system. The step of generating raw data comprises the steps of: collecting borrower data; collecting credit bureau data; collecting history data; collecting transaction data; collecting economic data; and collecting social media data, in accordance with a preferred embodiment of the present invention. In accordance with a preferred embodiment of the present invention, the borrower data comprises: a borrower's demographic profile; state of residence; annual income; marital status; and home ownership status; the credit bureau data comprises: a FICO score; a number of collections within a prior time period; types of credit lines; and a payment status history within a prior time period; and the transaction data comprises: an applicant's transaction history; and phone activity data.

The foregoing summary of the present invention with its preferred embodiments should not be construed to limit the scope of the invention. It will be apparent to one skilled in the art that based on the embodiments as described, features of the invention may be further combined or modified without departing from its scope.

### BRIEF DESCRIPTION OF THE DRAWINGS

Accompanying this written specification is a collection of drawings of exemplary embodiments of the present invention. One of ordinary skill in the art would appreciate that these are merely exemplary embodiments, and additional and alternative embodiments may exist and still within the spirit of the invention as described herein.

FIG. 1 illustrates a schematic overview of a system in accordance with an embodiment of the present invention.

FIG. 2 depicts a flow diagram illustrating an exemplary process of a preferred method for performing real-time risk assessment and decision making in accordance with an embodiment of the present invention.

FIG. 3 illustrates a schematic overview of a networked system, in accordance with an embodiment of the present invention.

FIG. 4 illustrates a schematic overview of a computing device, in accordance with an embodiment of the present invention.

### DETAILED DESCRIPTION OF THE INVENTION

The following description of the preferred embodiments of the invention is not intended to limit the invention to these preferred embodiments, but rather to enable any person skilled in the art to make and use this invention. The present invention relates to improved systems for scoring borrower credit, which includes individuals and other types of entities including, but not limited to, corporations, companies, small businesses, trusts, and any other recognized financial entity.

The present invention generally relates to a data processing system for incorporating network-based computational infrastructure within a statistical learning framework for real-time risk assessment and decision making.

The following definitions are not intended to alter the plain and ordinary meaning of the terms below but are instead intended to aid the reader in explaining the inventive concepts below:

As used herein, the term “RAW DATA” shall generally refer to a borrower's individual-level demographic information, such as, for example, age, gender, state of residence when filing the application, annual income, marital status, and home ownership. In addition, the RAW DATA may include account-level information from credit bureaus such as FICO score, the number of collections in the past 12 months, credit line types (e.g. auto, mortgage, home loan, etc.), and the 48-month payment status history. The RAW DATA may also include other types of data, including, but not limited to, transaction data (by category: grocery expenses, travel expenses, clothing expenses, education expenses, etc.), social media data, and mobile phone activity data.

As used herein, the term “BORROWER DATA” shall generally refer to borrower's individual-level demographic profile, such as age, gender, state of residence when filing the application, annual income, marital status, and home ownership.

As used herein, the term “CREDIT BUREAU DATA” shall generally refer to information retrieved or otherwise processed from credit bureaus, such as FICO score. The CREDIT BUREAU DATA may also include account-level information, such as the number of collections in the past 12 months, credit line types (e.g. auto, mortgage, home loan, etc.), and 48-month payment status history.

As used herein, the term “ECONOMIC DATA” shall generally refer to macro-economic factors, such as current prime interest rate, inflation rate, and consumer price indexes.

As used herein, the term “TRANSACTION DATA” shall generally refer to the applicant's transaction history (by category: grocery expenses, travel expenses, clothing expenses, education expenses, etc.).

As used herein, the term “HISTORY DATA” shall generally refer to an applicant's profile when borrowing in the past.

As used herein, “SOCIAL MEDIA DATA” shall generally refer to an applicant's data collected from various social media sources such as YouTube, Facebook, and Twitter. Primarily, the data is unstructured and contains user's opinion towards certain products, services and events.

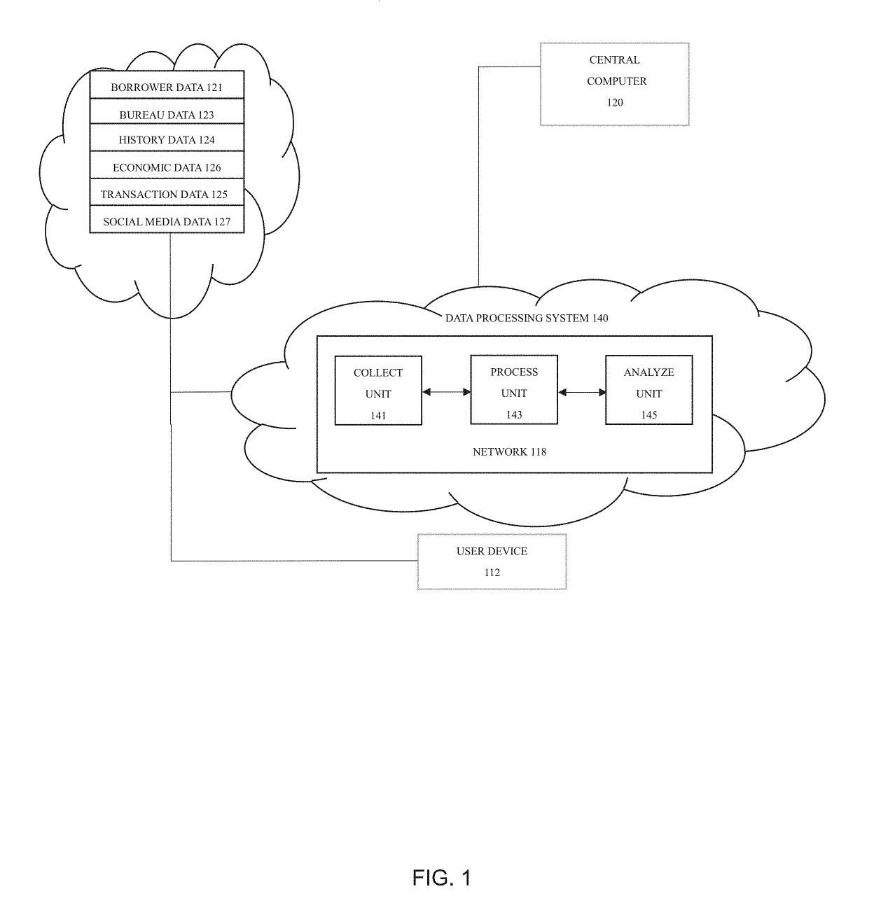

Referring to FIG. 1, a schematic overview of a system in accordance with an embodiment of the present invention is shown. As shown in FIG. 1, a preferred data processing system for incorporating a network-based computational infrastructure within a statistical learning framework for real-time risk assessment and decision making in accordance with a preferred embodiment can generally include a user device 112, a central computer 120, a network 118 and one or more data sources, including for example borrower data 121, credit bureau data 123, history data 124, transaction data 125, economic data 126, and social media data 127. The preferred embodiment of the system can include at least a central computer 120 and/or a user device 112, which function to provide the method detailed herein. The network 118 can include computer networks, such as the internet, local, metro, intranets, and/or other area networks. The network 118 can be used to access information resources via Hypertext Transfer Protocol (HTTP), Representational State Transfer (REST) architectural style, and Simple Object Access Protocol (SOAP), which can be displayed on at least one user device 112. A user device 112 can access a web server of the central computer 120 to retrieve a web page for display on the monitor or screen of user device 112. The central computer 120 should generally be understood to include an entity that operates the web page. For example, the central computer 120 may include at least one web page server that communicates with the network 118 to make the web page available to the user device 112. The data processing system 140 consists three main parts: collect unit 141, process unit 143 and analyze unit 145. The collect unit 141 can include at least one scalable storage infrastructure of a wide variety, including but not limited to Hadoop Distributed File System (HDFS), MapR File System, and Amazon S3. The process unit 143 includes the implementation of an interface for data parallelism and fault tolerance. The process unit 143 performs data filtering, sorting, inserting, querying, updating, summarization, deletion, schema creation and modification via programming algorithms such as MapReduce, Spark SQL, and/or Apache Hive. The analyze unit 145 is the preferred embodiment of the scalable machine learning pipelines operable to determine the creditworthiness of borrowers, by accessing, evaluating, measuring, quantifying, and utilizing a measure of risk based on the novel and unique methodology further described below.

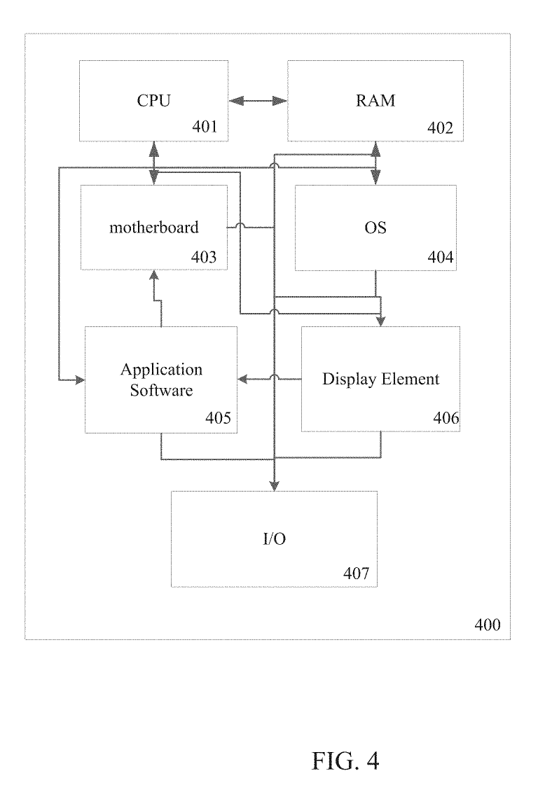

According to an embodiment of the present invention, the system and method may be configured to share with and/or receive data from one or more computing devices. As shown in FIG. 4, one of ordinary skill in the art would appreciate that any suitable computing device such as, but not limited to, either a user device 112 or a central computer 120 device, should be understood to be a computing device 400 appropriate for use with embodiments of the present system and may generally be comprised of one or more of the following: a central processing Unit (CPU) 401, Random Access Memory (RAM) 402, a storage medium (e.g., hard disk drive, solid state drive, flash memory, cloud storage) 403, an operating system (OS) 404, one or more system software 405, one or more programming languages 406 and one or more input/output devices/means 407. Examples of computing devices usable with embodiments of the present invention include, but are not limited to, personal computers, smartphones, laptops, mobile computing devices, tablet PCs and servers. The term ‘computing device’ may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

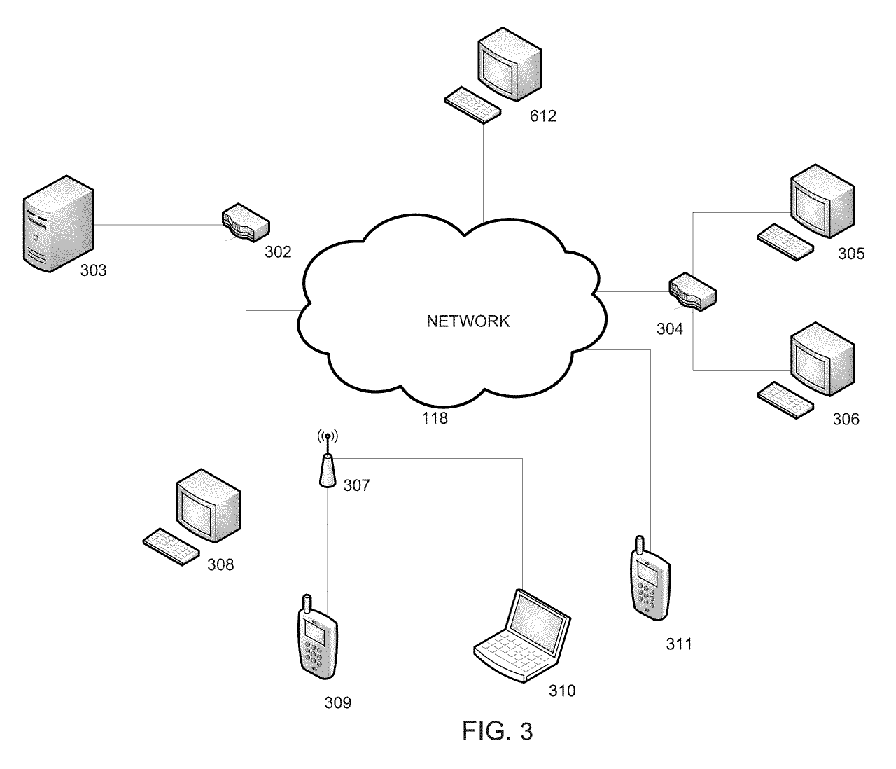

Referring to FIG. 3, a schematic overview of a cloud-based system in accordance with an embodiment of the present invention is shown. The cloud-based system is comprised of one or more system servers 303 for electronically storing information used by the system. Programs in the system server 303 may retrieve and manipulate information in storage devices and exchange information through a Network 118 (e.g., the Internet, a LAN, WiFi®, Bluetooth®, etc.) which is a variation of a preferred embodiment of the network 118. Applications in server 303 may also be used to manipulate information stored remotely and process and analyze data stored remotely across a Network 118 (e.g., the Internet, a LAN, WiFi™, Bluetooth®, etc.).

According to an exemplary embodiment, as shown in FIG. 3, exchange of information through the Network 118 may occur through one or more high speed connections. High speed connections may be over-the-air (OTA), passed through networked systems, directly connected to one or more Networks 118 or directed through one or more routers 302. Router(s) 302 are completely optional and other embodiments in accordance with the present invention may or may not utilize one or more routers 302. One of ordinary skill in the art would appreciate that there are numerous ways server 303 may connect to Network 118 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 303 via Network 118 or other network in numerous ways. For instance, a component may connect to the system i) through a computing device 312 directly connected to the Network 118, ii) through a computing device 305, 306 connected to the Network 118 through a routing device 304, iii) through a computing device 308, 309, 310 connected to a wireless access point 307 or iv) through a computing device 311 via a wireless connection (e.g., CDMA, GMS, 3G, 4G) to the Network 118. One of ordinary skill in the art would appreciate that there are numerous ways that a component may connect to server 303 via Network 118, and embodiments of the present invention are contemplated for use with any method for connecting to server 303 via Network 118. Furthermore, server 303 could be comprised of a personal computing device, such as a smartphone, acting as a host for other computing devices to connect to.

### Method Overview

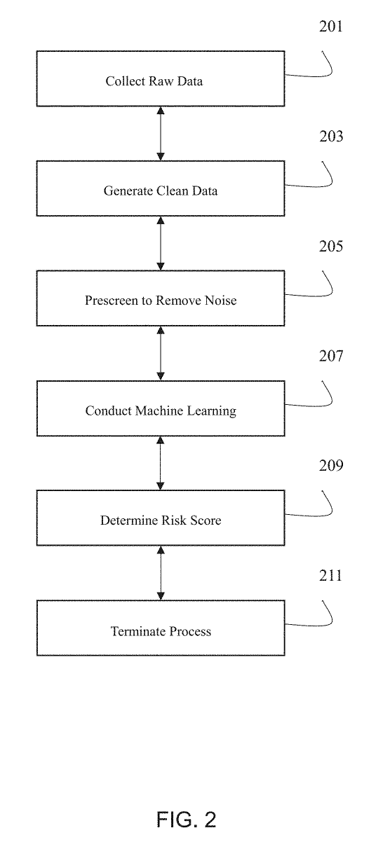

Referring to FIG. 2, the figure provides a flowchart illustrating one preferred method by which RAW DATA is collected, processed, and analyzed to build and validate a credit scoring function of some embodiments of the present disclosure. In some implementations of the present invention, the method illustrated in FIG. 2 of this preferred embodiment may obtain an indication from a user via a user device 112. For example, the indication of user interest may include the user accessing or interacting with online content provided by the central computer 120. More specifically, the indication may include user clicking, selecting, providing input, responding to a prompt for input, and photographing for facial recognition. The data processing system 140 performs the detailed method having the following steps:

Step 201: A requesting application receives a borrower's profile. According to a borrower's profile, the system will automatically collect borrower data 121, credit bureau data 123, history data 124, transaction data 125, economic data 126, and social media data 127 to generate RAW DATA. The RAW DATA is stored within at least one scalable storage infrastructure (e.g., Hadoop Distributed File System (HDFS), MapR File System, and Amazon S3).

Step 203: The RAW DATA is processed through data filtering, sorting, inserting, querying, updating, summarization, deletion, schema creation and modification via programming algorithms, such as MapReduce, Spark SQL, and Apache Hive, to produce CLEAN DATA. Thereafter, the CLEAN DATA is stored and prepared for downstream analysis.

Step 205: The CLEAN DATA is then moved to a pre-screening stage to remove excessive noise to improve the performance of the machine learning algorithms by stabilizing the variable selection procedure. For example, the inclusion criteria of a covariate may be based on the threshold of a statistical inference. A covariate with a statistical inference value higher than the threshold is considered to be a “true signal”; otherwise, a covariate is considered to be “noise”. The threshold may be a fixed, predetermined value or the threshold may be adaptive to the data collected.

Step 207: The CLEAN DATA is processed using statistical machine learning algorithms to further reduce dimensionality and enhance predictability. For example, the machine learning algorithms may include but are not limited to: tree-based, gradient boosting, support vector machine, deep learning, and the ensemble methods. In preferred embodiments of this invention, multiple algorithms may be run in parallel.

Step 209: Evaluating and comparing different ways of segmenting risk and choosing the best model and segmentation.

Step 211: The credit evaluation method of this preferred embodiment ends with Step 211.

Detailed processes of the steps of the credit evaluation method of this preferred embodiment are described below in detail.

In Step 201, RAW DATA is collected in response to a receipt of a borrower's data, credit bureau data, transaction data, and/or macro-economic data, social media data, and history data. The borrower's data may include a borrower's demographic profile, such as, age, gender, state of residence when filing the application, annual income, marital status, and/or home ownership. In addition, the credit bureau data may also include account-level information from credit bureaus such as, FICO score, the number of collections in the past 12 months, credit line types (e.g. auto, mortgage, home loan, etc.), and the 48-month payment status history. The transaction data may also include other types of data, including, but not limited to, the applicant's transaction history (by category: grocery expenses, travel expenses, clothing expenses, education expenses, etc.), social media data, and mobile phone activity data. The macro-economic data includes information such as, current prime interest rate, inflation rate, and consumer price indexes.

In Step 203, the RAW DATA is processed through data filtering, sorting, inserting, querying, updating, summarization, deletion, schema creation and modification. In some implementations of the present invention, the step 203 identifies identical records and delete the exact same subject when necessary. The duplicated record can be automatically identified by the system. For example, if an applicant accidentally applied multiple times, different applicant identity numbers may refer to the same applicant. The systems will automatically conduct fuzzy string matching on other demographic characteristics in an applicant's profile to identify duplicated applicant records. This procedure is different from identifying a recurrent applicant—a single applicant that intentionally applies for different loans, or a returning applicant who was approved for a loan previously. The system will automatically retain a single applicant with multiple applications at different time points.

The RAW DATA will be cleaned and transformed before entering into any downstream analysis. The system will then automatically separate numeric and string covariates. A typical data cleaning process includes, but is not limited to the sub-steps described below as follows:

For continuous numeric covariates the process includes, but is not limited to:
1) Transforming highly skewed covariate to an approximate normal distribution to stabilize the variance. A typical transformation is logarithmic transformation. Other possible transformations include, but are not limited to, centering and normalization.
2) Imputing the missing covariates. We typically assume the observations with missing values are missing at random (MAR) or missing at completely random (MACR) so that the missing values can be imputed using the corresponding covariate mean. For highly skewed covariates, the missing values may be imputed using the corresponding covariate median, as an alternative.
3) Removing any apparent outliers. An observation with value exceeding mean +/−3 standard deviations of a given covariate is considered to be an outlier, and is excluded from the analysis.
4) Categorizing continuous covariates into multiple levels: for example, continuous covariate “annual income” can be categorized into three levels: (i) high (>$100K), (ii) medium ($50K-$100K), and (iii) low (<$50 k);

The data management for categorical numeric covariates includes, but is not limited to:
1) Labeling the observations with missing information in categorical covariates using identical indicators. If a large proportion of observations has missing information, the system will drop the covariate from analysis. If only a few observations have missing information, the system will retain the corresponding covariate and treat missing value as a new category.
2) Converting covariates with characteristics values into numeric values. For example, covariate “home ownership” with three levels, namely, mortgage, rent, and own can be converted to the covariate with numeric values with 1 for mortgage, 2 for rent, and 3 for own, respectively;
3) Converting covariates with multiple levels into dummy covariates. For example, the aforementioned one covariate “home ownership” with 3 levels can break into 3 dummy variables: “home ownership1” (1—if mortgage; 0—otherwise), “home ownership2 (1—if rent; 0—otherwise) and “home ownership3” (1—if own; 0—otherwise). One of the dummy variables will be used as the reference level;

The data management for string covariates includes but is not limited to:
1) Converting dates into the standard form, e.g., dd/mm/yyyy.
2) Transferring addresses into standard form with case sensitive control, (e.g., Replacing “Towne Center dr” into “Towne Center Drive”).

To verify the authenticity of applicant's profile, the initial fraud screening includes, but is not limited to, using rule-based methods to detect possible fraud. Given a set of thousands of past loans, to build a predictive modeling and test its performance, one normally splits the full dataset into training and test subsets. There is no guideline for the allocation of training and test. Generally, the allocation can be 1:1 or 2:1, as long as it retains sufficient power in both datasets. For outcomes that are categorical with multiple levels or of the time-to-event type, it is necessary to keep all the levels in both training and test datasets so that the prediction accuracy can be evaluated without bias. In a more rigorous way, one can use advanced subsampling techniques, such as cross-validation or bootstrapping to account for sample variability. Once the final set of predictors is finalized, the training set is then put through the sequence of steps 205-209 in a “prescreen-selection-prediction” procedure. In a preferred embodiment of the present invention, this is done via parallel computing whereby the “prescreen-selection-prediction” procedure comprising steps 205, 207, and 209 described above is performed in each node (i.e. processor) of the system.

In step 205, after the RAW DATA is cleaned and transformed, it is then moved to a pre-screening stage. Pre-screening is a general procedure used commonly in statistical applications to remove excessive noise to improve performance of a machine learning algorithm, which, in general, leads to more accurate results as opposed to datasets without pre-screening. The noise can mix with the true signal, which is indistinguishable, and may lead to deterioration of the performance of the machine learning algorithm recovering the truth. The pre-screening procedure is of particular importance, especially when the number of covariates p is much larger than the number of sample size n—known as the “curse of high-dimensionality” scenario. Because of correlation and confounding existing pervasively in high-dimensional data, the assumption of independence among covariates for almost all prevalent machine learning models is easily violated. Acknowledging the difficulty of controlling for false positives, pre-screening is a necessary procedure to control type I errors as much as possible while retaining the true covariates that significantly contribute to the outcome. In some implementations of the present invention, the inclusion criteria of a covariate may be based on the threshold of a statistical inference. A covariate with a statistical inference value higher than the threshold is considered to be a “true signal”; otherwise, a covariate is considered to be “noise”. The threshold may be a fixed, predetermined value or the threshold may be adaptive to the data collected.

The pre-screening is essential to remove excessive noise and improve the performance in supervised learning algorithm in the step that follows. The classical pre-screening methods (e.g., forward and backward stepwise selection, best subset) often results in poor performance when the data is of non-polynomial dimensionality due to the violation of underlying theoretical assumptions. For example, the independence assumption of any two covariates is rarely held when the number of covariates increases as fast as the sample size. In addition, the classical method has a discrete structure and the selection procedure is highly volatile. The preferred embodiment addresses this problem and improves the performance by incorporating a sub-sampling scheme with univariate parametric screening or nonparametric correlation-based screening. This procedure can effectively reduce dimensionality and control for false positives while preserving the covariates that are significantly associated with the outcome.

In Step 207, the CLEAN DATA is processed using a real-time statistical machine learning algorithm. After pre-screening, the number of the covariates should be largely reduced. The amount of computational time for most machine learning algorithms grows with the number of covariates p—either cubically or exponentially. The accuracy of the estimate also depends on the ratio of sample size to the number of covariates. A small ratio indicates insufficient sample size, which may lead to invalid results with highly biased parameter estimates.

To measure creditworthiness, the invention uses a framework of a combination of competing risk models and machine learning algorithms. Typical competing risk models include two common types: a cause-specific hazards model and a subdistribution hazards (also known as Fine-Gray) model. The two common events associated with the lending industry are: prepayment and default. The common machine learning algorithms include, but are not limited to, adaptive lasso, gradient boosting machine, random forest, support vector machine, etc. It also includes the ensemble learning methods. There are several reasons why a machine learning algorithm is needed to further reduce dimensionality. First, the machine learning algorithm reduces the number of predictors to be smaller than the sample size n. With a handful number of predictors, it is feasible to calculate an individualized, unbiased risk score through the traditional statistical model, as the traditional model won't allow the number of predictors to go beyond or even get close to the sample size. Second, the smaller number of predictors, if selected following a scientific and legitimate manner, can represent the model behavior well when the underlying theoretical assumptions and conditions are met. As a rule, the algorithm to optimize an object function tends to fluctuate and become unstable as the number of predictors increases. Thus, a model with fewer number of predictors is generally preferred for stability reasons. Third, a simpler model can be generalized, and less vulnerable to changes in a test dataset. Ideally, a good predictive modeling should provide as much information as it gets, yet retain the same level of accuracy when applied to a new dataset.

In Step 209, the system validates the prediction to create a composite score. The purpose of creating a risk score is to distinguish applicants who are more likely to default from those less likely to default. Under the framework of competing risk, it also serves the purpose to separate applicants who are more likely to prepay the loans from those who are not. The preferred embodiments describe a semi-automatic way to build a real-time risk segmentation system, which combining the advantages of machine and human beings in decision-making. Specifically, the system is able to classify applicants to a few strata according to risk of default and prepayment, i.e., low, median low, median high and high. In each stratum, the applicants should share as many common properties as possible—the stratum is as homogeneous as possible.

### DETAILED DESCRIPTION OF THE PREFERRED EMBODIMENTS

The following description of the preferred embodiments of the invention is not intended to limit the invention to these preferred embodiments, but rather to enable any person skilled in the art to make and use this invention. The present invention relates to improved systems for scoring borrower credit, which includes individuals, and other types of entities including, but not limited to, corporations, companies, small businesses, and trusts, and any other recognized financial entity.

The RAW DATA generated in the preferred embodiment of the present invention, includes a borrower's demographic profile, such as, age, gender, state of residence when filing the application, annual income, marital status, home ownership. In addition, the RAW DATA may include account-level information from credit bureaus. For example, such credit bureau account-level information may include, the FICO score, the number of collections in the past 12 months, credit line types (e.g. auto, mortgage, home loan, etc.), and the 48-month payment status history. The RAW DATA may also contain other types of data, including, but not limited to, applicant's transaction history (by category: grocery expenses, travel expenses, clothing expenses, education expenses, etc.), social media data, mobile phone activity data, and macro-economic data.

The RAW DATA will be processed through data filtering, sorting, inserting, querying, updating, summarization, deletion, schema creation and modification, before entering into downstream analysis. A typical data cleaning process includes: 1) Converting covariates with characteristics values into numeric values. For example, the covariate “home ownership” with three levels: mortgage, rent, and own can be converted to the covariate with numeric values: 1—mortgage, 2—rent and 3—own; 2) Converting covariates with multiple levels into dummy covariates. For example, the aforementioned one covariate “home ownership” with 3 levels can break into 3 dummy variables: “home ownership 1” (1—if mortgage; 0—otherwise), “home ownership2” (1—if rent; 0—otherwise) and “home ownership3” (1—if own; 0—otherwise). One of the dummy variables will be used as the reference level; 3) Categorizing continuous covariates into multiple levels: for example, continuous covariate “annual income” can be categorized into three levels: high (>$100K), median ($50K-$100K) and low (<$50 k); 4) Transforming highly skewed covariates to approximate normal distributions to stabilize the variance. A typical transformation is logarithmic transformation; 5) Imputing the missing covariates. We typically assume the observations with missing values are missing at random so that the missing values can be imputed using the corresponding covariate mean; 6) Removing any apparent outliers. An observation with value exceeding mean +/−3 standard deviations of a given covariate is considered to be an outlier, and is excluded from the analysis.

The RAW DATA is then moved to the pre-screening stage. Pre-screening is a general procedure used commonly in statistical applications to remove excessive noise to improve performance of machine learning algorithms, which in general leads to more accurate results as opposed to datasets without pre-screening. The noise can mix with the true signal, which is indistinguishable, and may deteriorate the performance of machine learning algorithm to recover the truth. The pre-screening procedure is of particular importance, especially when the number of covariates p is much larger than the number of sample size n—known as the “curse of high-dimensionality” scenario. Because correlation and confounding are widely prevalent in high-dimensional data, the assumption of independence among covariates for almost all machine learning models is easily violated. Acknowledging the difficulty of controlling for false positives, pre-screening is a necessary procedure to control the type I error as much as possible while retaining the true covariates that significantly contribute to the outcome.

After pre-screening, the number of the covariates should be largely reduced. The amount of computational time for most machine learning algorithms grows with the number of covariates p—either cubically or exponentially. The accuracy of estimates also depends on the ratio of sample size and number of covariates. A small ratio indicates insufficient sample size, which may lead to invalid results with highly biased parameter estimates.

To measure creditworthiness, the framework of a combination of competing risk models and machine learning algorithms is used. The competing risk models include two common types: the cause-specific hazards model and the sub-distribution hazards (also known as Fine-Gray) model. In some implementations of the present invention, the two common events associated with lending industry considered herein are prepayment and default. The common machine learning algorithms include, but are not limited to: gradient boosting machine, random forest, support vector machine, deep learning, ensemble learning, etc. There are several reasons why a machine learning algorithm is needed to further reduce dimensionality. First, the machine learning algorithm reduces the number of predictors to be smaller than the sample size n. With a handful number of predictors, the model is interpretable. It is also feasible to calculate individualized, unbiased risk scores through the traditional statistical model, as traditional model will not allow number of predictors p to go beyond or even get close to the sample size n. Second, the smaller number of predictors, if selected following a scientific and legitimate way, can well represent the model behavior when the underlying theoretical assumptions and condition are met. As a rule, the algorithm to optimize an object function tends to fluctuate and become unstable as the number of predictors increases. Thus, a model with a fewer number of predictors is generally preferred for stability reasons. Third, a simpler model can be generalized, and is less vulnerable to changes in a test dataset. Ideally, a good predictive modeling should provide as much information as it gets, yet retain the same level of accuracy when applied to a new dataset.

The purpose of creating a risk score is to distinguish applicants who are more likely to default from those less likely to default. Under the framework of competing risk, it also serves the purpose to separate applicants who are more likely to prepay the loans from those who are not. The preferred embodiments describe a semi-automatic way to build a real-time risk segmentation system, which combines the advantages of machine and human beings in decision-making. Specifically, the system is able to classify applicants into several strata according to risk of default and prepayment, (i.e. low, medium low, medium high, and high). In each stratum, the applicants should share as many common properties as possible—the stratum should be as homogeneous as possible.

### DETAILED METHODS

The preferred method for building and validation of a credit scoring function involves the following steps: 1) data collection in response to a receipt of a user's indication; 2) data processing through filtering, sorting, inserting, querying, updating, summarization, deletion, schema creation and modification (i.e. removing outliers, imputing missing, transformation covariates with skewed distributions to meet the normality assumption, and converting strings or characters to numeric values); 3) Pre-screening the predictor space to remove excessive noise for stabilizing the variable selection procedure; 4) Running machine learning algorithms to further reduce dimensionality; 5) Constructing individualized risk scores for each types of event (i.e. default and prepayment) using the predictors selected in step 4); 6) evaluating and comparing the ways of segmenting risk as well as drawing final conclusions.

In the data collection step, a requesting application receives a borrower's profile. According to a borrower's profile, the system will automatically collect borrower data 121, credit bureau data 123, history data 124, transaction data 125, economic data 126, and social media data 127 to generate RAW DATA. The RAW DATA is stored within at least one scalable storage infrastructure (e.g., Hadoop Distributed File System (HDFS), MapR File System, and Amazon S3).

In the data processing step, the first sub-step is to identify identical records and delete the exact same subject when necessary. The duplicated record can be automatically identified by the system. For example, if an applicant accidentally applied multiple times, different applicant identity numbers may refer to the same applicant. The system will automatically conduct fuzzy string matching on other demographic characteristics in applicant's profile to identify duplicated applicant record. This procedure is different from identifying recurrent applicant—a single applicant who intentionally applies for different loans, or a returning applicant. The system will automatically retain a single applicant with multiple applications at different time points.

The system will then separate numeric and string covariates. The data management for continuous numeric covariates includes, but is not limited to: 1) Transforming highly skewed covariates to an approximate normal distribution to stabilize the variance. A typical transformation is a logarithmic transformation; 2) Imputing missing values in covariates. The system assumes observations are missing at random (MAR) or missing completely at random (MACR). The missing observations are imputed using the corresponding covariate mean or median, which results in better sampling distribution; 3) Removing any apparent outliers. An observation with values exceeding the mean +/−3 standard deviations of a given covariate is considered to be an outlier. The data management for categorical numeric covariates includes, but is not limited to: 1) Labeling the observations with missing information in categorical covariates using identical indicators. If a large proportion of observations have missing information, the system will drop the covariate from analysis. If only a few observations have missing information, the system will retain the corresponding covariate and treat missing value as a new category; 2) Converting categorical covariates with more than two levels into dummy covariates with each dummy covariate being dichotomous. For example, the covariate “home ownership” with three levels can be converted to three dummy covariates: “home ownership1” (1—if mortgage; 0—otherwise), “home ownership2” (1—if rent, 0—otherwise) and “home ownership3” (1—if own; 0—otherwise). Categorical covariates with two levels do not need transformation; 3) Setting the reference level and exclude the dummy variable representing the reference level from the data. The data management for string covariates includes, but not limited to: 1) Converting dates into the standard form (e.g. dd/mm/yyyy); 2) Transferring addresses into standard form with case sensitive control (e.g. Replace “Towne Center dr” into “Towne Center Drive”).

To verify the authenticity of applicant's profile, the initial fraud screening includes, but is not limited to, using rule-based methods to detect possible fraud. Given a set of thousands of past loans, to build a predictive modeling and test its performance, one normally splits the full dataset into a training set and test set. There is no guideline for the allocation of training and test. Generally, the allocation can be 1:1 or 2:1, as long as it retains sufficient power in both datasets. For an outcome that is categorical with multiple levels or survival type, it is necessary to keep all the levels in both training and test datasets so that the prediction accuracy can be evaluated without bias. In a more rigorous way, one can use advanced subsampling techniques, such as cross-validation or bootstrapping to account for sample variability. Once the final set of predictors is nailed down, the training set is then put through the sequence of steps 205-209 in a “prescreen-selection-prediction” procedure. In a preferred embodiment of the present invention, this is done via parallel computing whereby the “prescreen-selection-prediction” procedure comprising steps 205, 207, and 209 described above is performed in each node (i.e. processor) of the system.

The pre-screening is essential to remove excessive noise and improve the performance in the supervised learning algorithm in the step that follows. The classical pre-screening methods, (e.g. forward and backward stepwise selection or best subset) often results in poor performance when the data is of non-polynomial dimensionality due to violation of underlying theoretical assumptions. For example, the independence assumption of any two covariates is rarely held when the number of covariates increases as fast as the sample size. In addition, the classical method has a discrete structure and the selection procedure is highly volatile. The preferred embodiment addresses the problem and improves the performance by incorporating a sub-sampling scheme with univariate parametric screening or nonparametric correlation-based screening. This procedure can effectively reduce dimensionality and control for false positives while preserving the covariates that significantly associated with the outcome. In some implementations of the present invention, the inclusion criteria of a covariate may be based on the threshold of a statistical inference. A covariate with a statistical inference value higher than the threshold is considered as “true signal”; otherwise, a covariate is considered as “noise”. The threshold may be a fixed, predetermined value or the threshold may be adaptive to the data collected.

Given possible high-dimensionality aspects of the collected data, the preferred embodiment incorporates statistical learning algorithms (e.g., adaptive lasso, gradient boosting, tree-based method, support vector machine, neural network and ensemble, etc.) under the framework of the competing risk or multi-state model. The supervised learning algorithm further reduces dimensionality on top of the pre-screening procedure to build a predictive model. The tuning parameter associated with the optimal step in the supervised learning algorithm is chosen via cross-validation, information-based criteria so that it minimizes the empirical risk. In some implementations, in order to efficiently process and examine all possible methods, a scalable, parallel computing infrastructure may be implemented so that each candidate method will be processing on separate node simultaneously. The optimal sets of parameters for building the predictive models will be based on either the single best supervised learning method or the ensemble methods.

The rate of default is influenced by both micro and macro-economic factors. When the interest rate falls below what the interest rate was at the time the loan is initiated, the rate of prepayment will increase, and vice versa. The events of default and prepayment preclude each other (i.e. a loan that has been prepaid will never default). For a given time period when the macroeconomic factors are invariant, the risk of default alone increases in the early time after the loan is initiated. When the loan is seasoned, the rate of default tends to drop and stabilize over time. For a given applicant, the system can accurately estimate the probability of default and early prepayment for any given time point simultaneously. For the estimated probability, the system also provides a statistical inference (e.g. 95% confidence interval to quantify the accuracy of the estimate). An individualized risk assessment figure will be generated for each applicant. In addition, the system provides a flexible structure to allow more than two types of risks and conform it into a multi-state model. For example, the payment status before default can be further refined into several consecutive statuses (e.g. “0-30 days late”, “30-90 days late”, etc). Those statuses preclude each other and a change of status can happen in either direction with the prepayment and default as two absorbing statuses. The preferred embodiment includes a system to depict the cumulative prepayment and default probability while acknowledging other possible statuses. It is not uncommon for the recurrence of an applicant to happen. Thus, to increase the prediction accuracy, as an option, a more advanced model includes the frailty term incorporated therein to account for the within-subject correlation in the preferred embodiment.

In a preferred embodiment, the invention can obtain the risk score for an individual by using parameters estimated from the above steps. For multiple types of risks, there are multiple risk scores. Based on the distribution of the risk scores, the observations in the training samples can be assigned according to the risk segmentation. The optimal number of risk segmentations can be determined both automatically and manually. To assess the risk of a new applicant, a risk score will be determined by both the parameters estimated from the training sample and by the applicant's information. Based on the risk score, the new applicant will be assigned to the corresponding risk segmentation. For example, assuming there are two competing risks, namely early prepayment and default, by using applicant A's profile, the system automatically classifies applicant A to the group with low risk for early prepayment and high risk for default. The preferred embodiment provides an individualized chart consisting of cumulative default and prepayment incidences for any time point.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for incorporating computational infrastructure within a statistical learning framework for evaluating multiple types of risk simultaneously and decision making comprising:
at least one user device;
at least one central computer;
a data processing system;
at least one data source selected from the group comprising a borrower data source; a credit bureau data source, a history data source, a transaction data source, an economic data source, and a social media data source;
and a network communicatively connecting said at least one user device, said at least one computer, and said at least one data source.

2. The system of claim 1 wherein said at least one central computer is a server.

3. The system of claim 1 wherein said data processing system further comprises:
a collect unit,
a process unit, and
an analyze unit.

4. The system of claim 2 wherein said collect unit comprises at least one scalable storage infrastructure.

5. The system of claim 2 wherein the process unit includes an interface for data parallelism and fault tolerance.

6. The system of claim 1 wherein said user device is operable to access information resources on said network via at least one of HTTP, REST architectural style, and SOAP protocol.

7. A method for incorporating computational infrastructure within a statistical learning framework for evaluating multiple types of risk simultaneously for decision making comprising:
the step of receiving a borrower's profile;
the step of generating raw data;
the step of cleaning and transforming said raw data to generate clean data therefrom;
the step of pre-screening said clean data to remove excessive noise and stabilize a variable selection procedure;
the step of processing said clean data using at least one statistical machine learning algorithm to reduce the dimensionality of said clean data;
the step of evaluating and comparing risk segmentation options; and
the step of selecting a best model and a best segmentation.

8. The method of claim 7 further comprising the step of storing said raw data within a scalable storage infrastructure.

9. The method of claim 7 wherein the step of generating raw data comprises the steps of:
collecting borrower data;
collecting credit bureau data;
collecting history data;
collecting transaction data;
collecting economic data; and
collecting social media data.

10. The method of claim 9 wherein said borrower data comprises:
a borrower's demographic profile;
state of residence;
annual income;
marital status; and
home ownership status.

11. The method of claim 9 wherein said credit bureau data comprises:
a FICO score,
a number of collections within a prior time period;
types of credit lines; and
a payment status history within a prior time period.

12. The method of claim 9 wherein said transaction data comprises:
an applicant's transaction history, and
phone activity data.

13. A system for incorporating computational infrastructure within a statistical learning framework for evaluating multiple types of risk simultaneously and decision making comprising a non-transitory, computer readable recording medium containing a computer program, which when executed by at least one of a plurality of processors, causes said at least one of a plurality of processors to perform the steps of:
receiving a borrower's profile;
generating raw data;
cleaning and transforming said raw data to generate clean data therefrom;
pre-screening said clean data to remove excessive noise and stabilize a variable selection procedure;
processing said clean data using at least one statistical machine learning algorithm to reduce the dimensionality of said clean data;
evaluating and comparing risk segmentation options; and
selecting a best model and a best segmentation.

14. The system of claim 13 further comprising a non-transitory, computer readable recording medium containing a computer program, which when executed by said at least one of a plurality of processors, causes said at least one of a plurality of processors to perform the step of storing said raw data within a scalable storage infrastructure.

15. The system of claim 13 wherein the sequence steps of processing said clean data using at least one statistical machine learning algorithm to reduce the dimensionality of said clean data, evaluating and comparing risk segmentation options, and selecting a best model and a best segmentation are performed via parallel computing wherein said sequence is performed on each of said at least one of a plurality of processors.

16. The system of claim 13 wherein the step of generating raw data comprises the steps of:
collecting borrower data;
collecting credit bureau data;
collecting history data;
collecting transaction data;
collecting economic data; and
collecting social media data.

17. The system of claim 16 wherein said borrower data comprises:
a borrower's demographic profile;
state of residence;
annual income;
marital status; and
home ownership status.

18. The system of claim 16 wherein said credit bureau data comprises:
a FICO score,
a number of collections within a prior time period;
types of credit lines; and
a payment status history within a prior time period.

19. The system of claim 16 wherein said transaction data comprises:
an applicant's transaction history, and
phone activity data.
